(19) United States
(12) Patent Application Publication
(10) Pub. No.: US 2002/0010848 A1
(43) Pub. Date: Jan. 24, 2002

(54) Data processing system

(76) Inventors: Shoichi Kamano, Tokyo (JP); Shintaro Shimogori, Tokyo (JP); Mitsumasa Yoshimura, Tokyo (JP); Yoshihide Sugiura, Tokyo (JP)

Correspondence Address: BURNS DOANE SWECKER & MATHIS L L P, POST OFFICE BOX 1404, ALEXANDRIA, VA, 22313-1404, US

(21) Appl. No.: 09/860,563

(22) Filed: May 21, 2001

(30) Foreign Application Priority Data
May 29, 2000 (JP) 2000-158222

(51) Int. Cl. G06F 15/00

(52) U.S. Cl. 712/34

(57) ABSTRACT

A data processing system is provided that includes a special purpose data processing unit (VU) specialized in a specific data processing according to a special purpose instruction, and a general purpose data processing unit (PU) capable of designating processes by general purpose instructions, and an instruction issue unit for supplying signals corresponding to the special purpose instruction and the general purpose instructions to the PU and the VU respectively, the instruction issue unit being an application-specific unit. By replacing the instruction issue unit with a sequencer specialized in the application, a reliable, compact, low-power consumption data processing system is provided in a short period using the resources resulting from optimization with the programmable VUPU processor capable of flexibly dealing with the specification change while maintaining the real-time response.

### BACKGROUND OF THE INVENTION

1. Technical Field

The present invention relates to a data processor including a special purpose circuit.

2. Description of the Related Art

It is no exaggeration to say that recent improvement in the speed and capacity of the network as well as diversification of applications requiring a real-time operation or processing know no bounds. Such a real-time operation or processing is also required for a processor upon executing an application such as image processing, and particularly, data compression and decompression. As a result, processors for use in high-speed personal computers and game machines operate at an extremely high clock frequency so as to have the ability to process a plurality of applications at a high speed. However, these processors have general-purpose features and therefore cannot deal with all the requirements for real-time processing.

In contrast, a special purpose circuit or specific circuit specialized in a specific processing by using the hard-wired logic or the like can be designed to be capable of real-time response if required for the processing. Accordingly, in the field of applications for which the real-time response is highly required and even a one-clock delay in the data processing would make the processors unpractical, the response must be ensured by specialized circuits.

Therefore, a controller formed from specialized circuits is prominently required in the communication, network and image processing. However, in the field of such applications, an industry-standard specification is important, and only the products compliant with this standard can be brought to the market. Accordingly, every company is trying to affect determination of the specification, and if the specification is determined, immediately produces that system on a commercial basis so as to place it on the market, thereby assuring the company's market share. This requires a reduced design period, in particular, a reduced design period of the system LSIs (large scale integrated circuits), and also flexibility with a subsequent change in the specification.

While, the special purpose or special purpose circuit requires a long design and verification period, and is hardly flexible with a change in the specification. Accordingly, the special purpose circuit is required in terms of the performance, but is not likely to be practical in view of the environment in which the system LSIs are designed and developed. However, a general-purpose processor is often insufficient in terms of real-time response, as described above.

A data processing system or processor having a general purpose data processing unit (PU) capable of general-purpose processing on the scale that is equal to or smaller than that of the above general-purpose processor, and a special purpose data processing unit (VU) that is dedicated for special purpose and specialized in a specific data processing, is proposed. In this data processor, a special purpose or dedicated instruction for operating the VU is included in a program of the data processor, as well as a general purpose instruction, therefore, the VU is called by the program for processing the process a real-time response is required. Accordingly, the specification of the data processor is changed by the program level or by the processing of the PU.

Moreover, the processor comprises of a basic architecture including a fetch unit (FU) for fetching a program; a decoder and the PU having basic instruction sets and the VU changeable on an application-by-application basis. Accordingly, in this processor, the design and development period can be reduced, and a proven special purpose circuit can be introduced as the VU. Therefore, by the architecture employing the general purpose data processing unit (PU) and the special purpose data processing unit (VU), it is possible to develop in a short period a system corresponding to an application for which the real-time property is required, and to flexibly deal with a subsequent design change and the like.

However, there always exists a need for a high-performance data processor as a system LSI, e.g., a low-power consumption, low-cost, compact size data processor. It is therefore an object of the present invention to provide a data processor based on the above described architecture and capable of reducing the power consumption and the occupied area without sacrificing the real-time response and the flexibility.

### SUMMARY OF THE INVENTION

In order to reduce the power consumption and the occupied area without sacrificing the real-time property, it is possible to implement or replace the function to be performed by the general purpose portion such as the PU with specialized circuits. If the entire general purpose structure is implemented using a specialized circuit, an unused portion in the circuit structure, unused registers are eliminated, so that the circuitry becomes a simple structure according to the purposes. As a result, the circuit scale is reduced, whereby reduction in power consumption and occupied area is realized. However, such implementation using specialized circuits eliminates possibility of short time developing and flexibility, making it difficult to catch up a specification change.

In a stage where a change or modification is no longer required because the specification of the system comprises of processor and application has been fixed or because the system has become mature, or in a stage where reduction in power consumption is given priority over the change or modification of the system, sacrificing the flexibility of the processor may be allowed. However, for re-designing and re-verification of the circuitry are required in order to implement the portion such as the PU with a specialized circuit. This requires an enormous amount of time and costs, reducing the advantage of implementation using the specialized circuit.

Therefore, in the present invention, only the portion for issuing an instruction to the VU and the PU is implemented using a hardware logic system specialized in the application without changing the structure of the VU and the PU. Thus, the portion functioning to fetch and decode the program is realized with a compact structure, allowing for reduction in power consumption and occupied area. More specifically, the data processing system of the present invention comprises at least one special purpose data processing unit specialized in a specific data processing according to a special purpose instruction, a general purpose data processing unit for executing processes according to general purpose instructions, and an instruction issue unit for supplying signals corresponding to the special purpose instruction and the general purpose instruction to the special purpose data processing unit and the general purpose data processing unit, respectively, and the instruction issue unit is specialized of an application like an application-specific unit.

Implementing or realizing the instruction issue unit as an application-specific unit, i.e., implementing it using a specialized circuit degrades the flexibility. However, implementing only the instruction issue unit using the specific or specialized circuit reduces the time and costs required for design and verification from a programmable structure. Moreover, since the functionality of the data processing system, excluding the instruction issue unit itself, has been verified by a program controlled issue unit having code memory and a fetch unit, re-designing and re-verification of the entire data processor are not necessary. Only a verification of the instruction issue unit implemented with the specialized circuit is required for reproducing the decoded state of the program. Accordingly, using the past resources obtained from the program initially development and verification, a reliable, compact size and low-power consumption data processor can be provided in a short period.

Namely, the data processing system including the special purpose data processing unit (VU), the general purpose data processing unit (PU) and the instruction issue unit for supplying the special purpose instruction and the general purpose instructions to the VU and the PU respectively is developed by a method comprises a first step or stage in which the instruction issue unit being programmable and a second step or stage in which the instruction issue unit being specialized of the application.

One of the appropriate means for implementing the instruction issue unit using the logic circuit or the special purpose circuit is a sequencer. The sequencer sequentially outputs preset control signals in a hardware manner. In order to directly use the verified resources of the special purpose data processing unit (VU) and the general purpose data processing unit (PU), it is desirable that the instruction issue unit specialized of the application has the same interface with the programmable instruction issue unit that is applied for the initially development and/or verification stage of the processor in the above first step. It is therefore effective for the instruction issue unit of this invention to supply or issue the signals equivalent to decoded control signals that are resultant of decoding the special purpose instruction and the general purpose instruction of a program by the programmable instruction issue unit.

In the programmable instruction issue unit, outputting a nop (no-operation) instruction to the PU when outputting the special purpose instruction to the VU enables the PU and VU to be controlled by the program having a sequential flow. Therefore, even when the instruction issue unit is implemented using the specialized circuit, the verified performance can be maintained by outputting the nop instruction to the PU simultaneously.

### BRIEF DESCRIPTION OF THE DRAWINGS

The aforementioned and other objects and advantages of the present invention will become apparent to those skilled in the art upon reading and understanding the following detailed description with reference to the accompanying drawings.

In the drawings:

FIG. 1 shows a programmable VUPU processor;

FIG. 2 shows a sequencer-type VUPU processor according to the present invention;

FIG. 3 shows an example structure for outputting a nop instruction to a PU in the sequencer-type VUPU processor;

FIG. 4 shows optimization process from a C language program through the programmable VUPU to the sequencer-type VUPU; and

FIG. 5 is a graph roughly comparing the number of gates between a sequencer type and a program control type.

### DESCRIPTION OF THE PREFERRED EMBODIMENTS

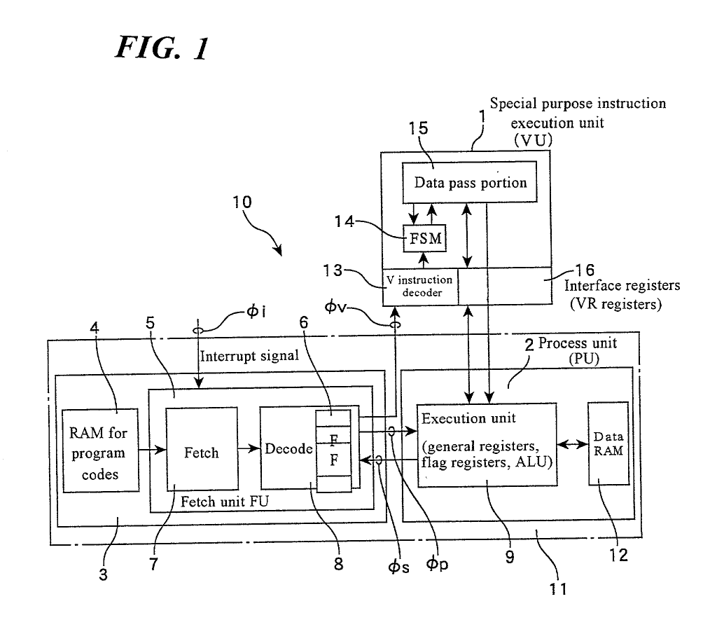

Hereinafter, the present invention will be further described with reference to the accompanying drawings. FIG. 1 schematically shows the structure of a programmable data processing system, i.e., a programmable processor 10, that includes a special purpose data processing unit or special purpose instruction execution unit (hereinafter, referred to as VU) 1 specialized in a specific processing, and a general purpose data processing unit or general purpose instruction execution or process unit (hereinafter, referred to as PU) 2 having a general-purpose structure. This processor 10 includes an instruction issue unit 3 providing a decoded control signal to the VU 1 and the PU 2. The instruction issue unit or dispatch unit (hereinafter, referred to as DU) 3 includes a code RAM 4 incorporating executable program codes (microprogram codes) therein, and a fetch unit 5 for fetching an instruction from the code RAM 4. The fetch unit (hereinafter, referred to as FU) 5 includes a fetch portion 7 for fetching an instruction from an address of the code RAM 4 that is determined by a previous instruction, the state of a state register 6 or an interrupt signal φi, and a decode circuit 8 for decoding a fetched special purpose instruction or general purpose instruction (general instruction) so as to supply a decoded control signal φv of the special purpose instruction or a decoded control signal φp of the general purpose instruction to the VU 1 and the PU 2 respectively. The PU 2 returns an exec unit status signal φs indicating the execution state so that the respective states of the PU 2 and the VU 1 are reflected in the state register (status register) 6.

The PU 2 includes a highly general-purpose execution unit (EU) 9 that has a general-purpose register, a flag register, an arithmetic unit (ALU), and a data RAM 12 serving as a temporary storage area when a process is conducted in the EU 9. The instruction issue (instruction-issuing) unit (DU) 3, the general purpose data processing unit (PU) 2, the code RAM 4, the FU 5 and the execution unit 9 is the same as that of a general process unit. Accordingly, the processor 10 of this embodiment has a configuration that the DU 3 and the PU 2 forming a processor unit 11 controls the VU 1.

The special purpose data processing unit (VU) 1 for executing the special purpose instruction φv from the DU 3, which is the same as from the processor unit 11 includes a unit 13 for decoding and judging whether the instruction supplied from the DU 3 is the special purpose instruction (V instruction) φv, when the instruction is φv and multi VUs are applied, that V instruction φv is for activating the VU 1 itself The VU1 also includes an FSM (Finite State Machine) 14 for outputting a control signal in a hardware manner so as to conduct a specific data processing, a data path portion 15 designed so as to conduct the specific data processing according to the control signal from the FSM 14, and an interface register 16 for interfacing with the PU 2. The internal state of the VU 1 can be referred to at the PU 2 through the interface register 16. The processing result of the data path portion 15 is able to supply to the PU 2 for a process sequentially performed in the PU2. The FSM 14 is adopted to realize a special purpose circuit (a specialized of some process) based on a hardware sequence control method. The FSM 14 is a finite state machine having a state in a register and outputting a control signal according to the state. The combination circuit determines the state transition based on a current state and an input signal.

The processor 10 shown in FIG. 1 stores in the code RAM 4, code ROM is also possible, a program including the general-purpose instructions (P instructions) and the special purpose instruction(s) (V instruction). The fetch unit 5 fetches the instructions from the program, and the instruction issue unit (DU) 3 outputs the instructions as the decoded control signals φp or φv. Among the signals φp and φv, the VU 1 identifies using the decode unit 13 the decoded control signal φv for activating the VU 1 itself, then the VU 1 is activated.

While, DU 3 supplies the PU 2 only the decoded control signal φp of the general-purpose instruction. Therefore, an instruction that cannot be executed by the PU 2, i.e., the decoded V instruction, is not issued to the PU 2. Instead, DU 3 supplies a control signal indicating a nop instruction involving no execution so as to skip the processing in the PU 2. Issuing the nop instruction instead of the decoded control signal of the V instruction eliminates the need for the PU 2 to deal with the V instruction or its decoded control signal.

The VU 1 is changeable according to an application to be performed by the processor 10, and in many cases, the special purpose instruction for instructing the VU 1 is also corresponding to the change of the VU. Therefore the VU 1 is an application-specific circuit, and it is easy to design the VU 1 so as to interpret the decoded control signal of the special V instruction. However, the PU2 is the common for the applications. Outputting the nop instruction to the PU 2 eliminates the need for the PU 2 to deal with an instruction specialized for the VU 1. The PU 2 need only have a function to interpret a basic instruction or a general purpose instruction for execution. Accordingly, the PU 2 can coexist with the VU or VUs 1 according to various applications without sacrificing the general-purpose property, and thus controlling these VUs 1 and conducting process cooperatively.

Thus, the processor 10 of FIG. 1 has a special purpose circuit (VU) 1 capable of implementing real-time response and a general-purpose process circuit (PU) 2. This configuration allows the processor 10 to be designed and developed in a reduced period without sacrificing the real-time response, and to flexibly deal with a subsequent change or modification. The present invention is not limited to the single special purpose circuit (VU) 1. A plurality of special purpose circuits (VUs) 1 may alternatively be prepared so as to enable a special purpose processing required by the application to be conducted, and a plurality of special purpose instructions for operating the respective special purpose circuits (VUs) 1 are included in the program code.

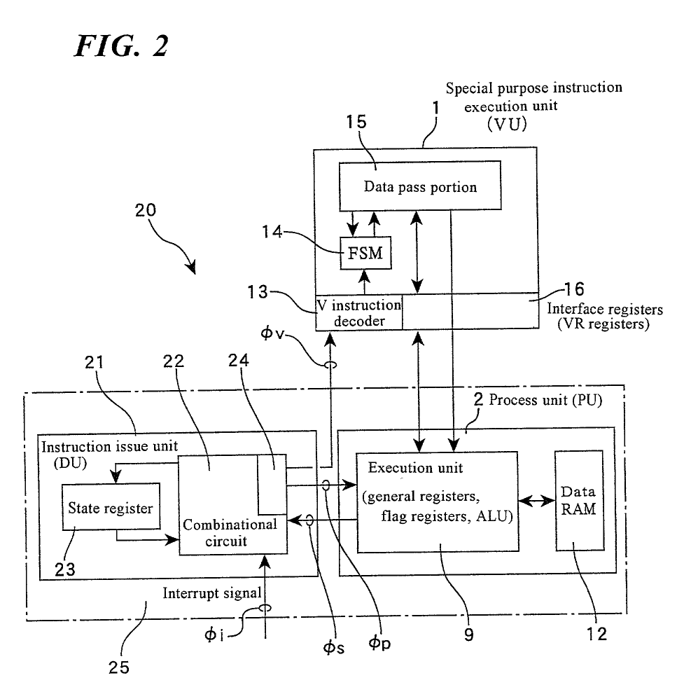

FIG. 2 schematically shows the structure of a processor 20 according to the present invention. Like the processor 10 of FIG. 1, the processor 20 is a data processing system including the specific data processing unit (VU) 1 specialized in the specific processing, and the general purpose data processing unit (PU) 2 having the general-purpose structure. The respective structures of the VU 1 and the PU 2 are the same as those of the programmable processor 10 shown in FIG. 1. The processor 20 includes an instruction issue unit (DU) 21 formed from a FSM 22 that is combinational circuit for hardware sequence control. This combinational circuit 22 is one of specialized circuit for outputting control signals φp and φv according to the state transition determined based on a combination of the current state of a state register 23 and an input signals such as interrupt signal φi and status signal φs from the PU2.

The control signals φp and φv respectively corresponding to a general purpose instruction and a special purpose instruction, which are output from the combinational circuit 22 in the DU 21 of this embodiment in response to the state transition, are the same control signals as those of supplied from the aforementioned programmable DU 3 resulting from decoding the program. Therefore, interface between the VU 1 and PU 2 and the DU 21 is completely the same as that of the programmable DU 3. Accordingly, in the processor 20 of this embodiment, the combination of the DU 21 and the PU 2 can also be designed as a sequencer-based process unit 25. In such a case, the configuration of this processor 20 becomes a combination of the sequencer-based process unit 25 and the VU 1 being as same as that in the programmable processor 10.

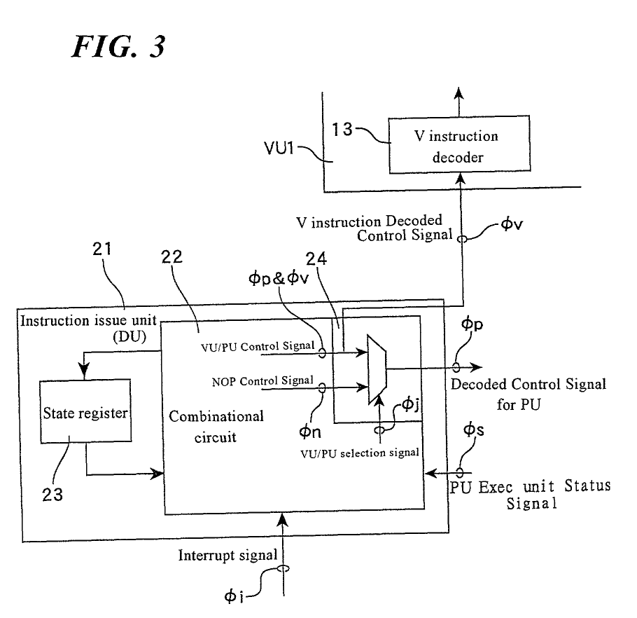

The DU 21 outputs the control signal of the nop instruction to the PU 2 when it issues the control signal φv of the V instruction, in order that the interface with the VU 1 and the PU 2, and the timing of issuing the control signals φp and φv are the same manner as that of the programmable DU 3. FIG. 3 shows one of an interface circuit 24 of the combinational circuit 22. In this example, the combinational circuit 22 sequentially outputs the decoded control signal φv of the V instruction and the decoded control signal φp of the general-purpose instruction, according to the state transition. The decoded control signals φv and φp are supplied to the VU 1 and then interpreted by the decode unit 13 of the VU 1. The decoded control signals φv and φp are also applied to a selector 27 of the interface circuit 24. The control signal φn of the nop instruction is also applied to the selector 27. The combinational circuit 22 outputs a VU/PU selection signal φj indicating whether the output instruction is the V instruction or the P instruction. In response to the VU/PU selection signal φj, the selector 27 selects the decoded control signal φp of the P instruction or the control signal φn of the nop instruction for supply to the PU 2.

Accordingly, in the processor 20 of this embodiment as well, no decoded signal φv of the special purpose instruction is supplied to the PU 2, and the PU 2 need only have a function to interpret the general purpose instructions for operation. Since the nop instruction is supplied to the PU 2 at the timing the V instruction is supplied, the instruction issue unit (DU) 21 can output or supply the P instruction and the V instruction in a prescribed order according to the state transition. Accordingly, the DU 21 need not have such a complicated structure. Namely, it is not necessary to handle the P instruction and the V instruction by separate, different FSMs and controls them at the synchronized timing for parallel processing, but only sequentially controlling these instructions by a single FSM allows the processor 20 to control the VU 1 and the PU 2 in parallel. Therefore, the timing of controlling the VU 1 and the PU 2 in parallel can be adjusted easily by the order of the control instructions φv and φp that are output according to the state transition. Accordingly, although being very simple in structure, adjustment or arbitration of the parallel processing of the VU 1 and the PU 2 are exactly controlled at the timing the combinational circuit 22 outputs a control instruction, i.e., by a unit of clock.

Thus, the processor 20 of this embodiment includes and drives in parallel the VU 1 formed from the specific circuit specialized in the specific process that has excellent real-time response, and the PU 2 suitable for general-purpose processing and flexible control. Accordingly, the parallel-processing capability of the special purpose processing unit(s) and the general purpose processing unit is improved without sacrificing the real-time response in this processor 20. So, the control using the interrupt signal φi that is important in an image-processing or game application, is easily incorporating in the processor 20.

In addition, in the processor 20, the DU 21 formed from the combinational circuit, which is the specific or special circuit based on the sequencer control method, outputs the decoded control signals φv and φp to the VU 1 and the PU 2, instead of the programmable instruction issue unit DU 3 includes the code RAM, the fetch portion, the decode circuit and the like. This enables the entire processor to be designed as a compact processor, allowing for reduction in power consumption as well as manufacturing costs.

Applying the specialized circuit type DU 21 makes it difficult to deal with a change in specification of the processor and/or application. Accordingly, it is difficult to employ the processor 20 of this embodiment in the early stage for developing the processor having the VU for processing the application for which the real-time response is required. Therefore, the processor 20 is employed in the second stage that the specification has been fixed to a certain degree using the processor 10 provided with the programmable DU 3 (first stage) and a further change in the specification hardly occurs.

More specifically, in the processor, which is referred to as a VUPU processor, includes the VU 1, the PU 2 and the programmable DU 3 for controlling the VU and PU, special purpose instructions i.e., V instructions are prepared for some special operations and the PU calls VU using that V instructions. Accordingly, in the program to be fetched by the programmable DU 3, the V instructions are embedded among P instructions string and P instructions are present before and after the V instruction for calling the VU. Therefore, even after the VU is fixed, combination of the general purpose instructions, i.e., the P instructions, can be changed and the processes to be performed by the processor PUVU can be changed.

For example, according to the specification, the V instruction for performing multiply by a variable, multiply, divide, and calculate the remainder sequentially is prepared. In case the some specification change is required, the process to be performed in the VUPU processor 10 can be changed, even if the V instruction itself does not change, by changing the conditions for calling the V instruction, because it is possible to flexibly change the call conditions by changing the order of the P instructions or the order of the P and V instructions in the program. The specification changes, which affect the processing contents to be performed by the special purpose instruction, would affect the VU architecture itself However, the minor specification changes, which do not affect the processing contents to be performed by the special purpose instruction, are flexibly followed by the program to be fetched by the DU 3 without changing the architectures of the VU and PU, and such the minor changes, which affect the conditions for applying the special purpose instruction (i.e., the control situations), are common occurred. Therefore, the initial stage for developing the processor, the processor having the programmable DU 3 is the most effective.

However, when the specification is entirely fixed and is not likely to be changed, the PU need no longer be flexible, and it is desirable that the PU is fixed. In other words, the PU need no longer be changeable by the software. This is because the mechanism capable of dealing with a change in the specification may cause excessive costs or disadvantages in terms of economic and product aspects. In particular, the code RAM having the software therein contributes to excessive costs in terms of the area and the power consumption.

According to the above requirement, in this invention, the processor is implemented using the hardware logic on the basis of the instruction issue unit DU, but it is also possible to the entire processor is implemented using another large hardware logic by reviewing the entire processor in terms of the circuit structure. By reviewing the circuit structure of the entire processor so as to implement the processor with the hardware, the entire processor is optimized for an application to be processed. Therefore, manufacturing such a processor has a great effect on the economic and performance aspects. However, it is difficult to make effective use of knowledge resources or empirical resources accumulated during the development and use of the programmable VUPU processor. In contrast, the processor 20 of this embodiment is capable of making effective use of various resources accumulated from the programmable VUPU, allowing the hardware-implemented, reliable VUPU to be developed in a short period.

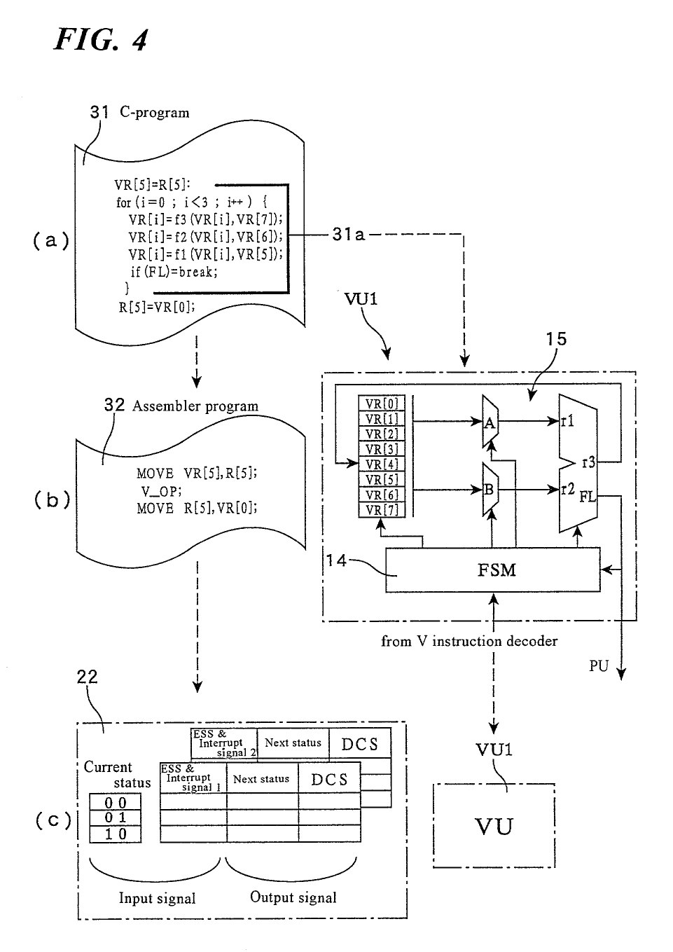

FIG. 4 shows one of developing steps according to this invention. For implementing the program 31 described in the C language shown in FIG. 4(a) as the VUPU processor, the program 31 is compiled to assembler codes for making executive form (PU program code) 32 of the PU as shown in FIG. 4(b). At this time, a portion where the high-speed and real-time processing is required is manually or automatically converted to the VU 1. The portion 31a of the C-source code 31 in FIG. 4(a) is replaced with special purpose hardware, i.e., the VU 1. Namely, that part of the C-source code is manually or automatically converted into an RTL model in the logic design stage, and a logic circuit for executing or implementing that RTL is designed and developed as the VU 1 shown in FIG. 4(b). Then, an instruction for operating the VU is prepared as the special purpose instruction (V instruction) for calling the VU in the program 32. Accordingly, the special purpose instruction (“V-OP” in this embodiment) and other P instructions are described in the assembler description of the PU program code 32.

In the portion 31a of the C-source code 31, functions f1 to f3 (processing such as addition and subtraction) are performed in the “for” statement. For executing this “for” statement with the single special purpose instruction, the VU 1 having a data path portion 15 for performing these functions f1 to f3 and an FSM 14 for controlling the data path portion 15, including interface registers VR, is realized with the hardware. The V instruction for activating the FSM 14 is V-OP and this V instruction is embedded in the assembler program 32 for the PU as shown in FIG. 4(b). Therefore, at the first developing step, the programmable VUPU processor 10 shown in FIG. 1 is supplied and the programmable VUPU processor 10 is controlled with this program 32.

As explained, since the only the P instruction is added, changed and/or deleted by the assembler program 32 having the V instruction in the case where the change in the specification does not extend to the V instruction, the programmable VUPU processor 10 is very convenient for adding and changing the specification while the VUPU processor 10 is factually incorporated into the system for performing the application. Provided that the stage of adapting the C language program for the programmable VUPU processor is first optimization, the stage of using the PU assembler program 32 in the real system for brush-up becomes second optimization.

Therefore, it is useful to applying a method for developing the VUPU processor comprising the first optimization for developing the VU for implementing a part of the specification of the application, and the program for performing the specification using the V instruction and the P instructions; and the second optimization for optimizing the program using the VUPU 10 adopting the programmable DU 3.

When the trial-use or the first development stage of the assembler program 32 applied to the real system is completed, the second optimization is also almost completed at that time, whereby the specification is fixed. Accordingly, the programmable specification is no longer required, so that the structure such as a program code RAM becomes an excessive system in the processor after the second optimization, as described above.

In this embodiment, as shown in FIG. 4(c), each step of the assembler program 32 is therefore allocated to the respective states so as to be performed by the sequencer realized in the combinational circuit 22. Thus, the VUPU processor 10 is optimized also in terms of the hardware so as to be provided as economical processor 20 as shown in FIG. 2. This second stage becomes third optimization. In this embodiment, the inputs of the combinational circuit 22 for the sequencer, are the interrupt signal φi to the process unit 25 and the status signal φs from the PU 2. The status signal φs is a signal that transmits the state of the facilities of the PU (PU execution unit), i.e., a general-purpose register, flag register, ALU and the like. The outputs of the combinational circuit 22 are the same control signals as those supplied from the instruction issue unit (DU) 3 in the programmable VUPU 10 those are the decoded control signals of the program. Accordingly, in the third optimization, not only the structure of the PU 2 but also the structure of the VU 1 need not be changed, and only the function of the instruction issue unit DU is replaced with the hardware. Accordingly, if the function of the specialized circuit for the DU 21 is confirmed, a proven, reliable processor 20 is provided without re-designing and verifying the entire processor. In addition, the VUPU is optimized in terms of the hardware to realizing small-size and low power consumption with compacting the instruction issue portion of the programmable VUPU that occupies relatively large area and power consumption. Therefore, this third optimization is also highly advantageous.

Further, in the sequencer-based VUPU processor 20 of this embodiment, signals associated with the fetch unit of the PU portion of the programmable VUPU processor 10 are replaced with signals of the sequencer generated, whereby only a very small amount of additional verification is required to the sequencer.

In addition, in replacing the assembler code with the sequencer, if the assembler code dose not use all of the general-purpose registers prepared in the PU 2, the unused general-purpose registers can be deleted from the PU 2 with only a slight change in the hardware of the PU 2. As a result, not only the RAM in which the assembler code is to be stored is deleted, but also the unused general-purpose registers that are mounted without being used are deleted upon fixing the assembler code with the sequencer. Therefore, external signals of the sequencer may be reduced because the external signals includes the decoded control signals φv and φp associated with the fetch unit 5 of the programmable VUPU processor 10, and the status signal φs from the PU 2 those signals are a subset or equal of the signals of the programmable VUPU 10.

Thus, in the processor 20 of this embodiment, the instruction issue unit DU is implemented using the special circuit, and the interface between the DU and the VU and PU is the same as that of the programmable VUPU. This enables the third optimization for replacing the programmable VUPU with the hardware logic type VUPU to be conducted by making effective use of the resources of the first optimization from the C language to the programmable VUPU and the resources of the second optimization of adapting the programmable VUPU to the real system. Accordingly, by replacing the DU with the specialized circuit in the specification of the application, a compact, low-power consumption application-specific processor having excellent real-time response and high reliability is developed in a short period.

Moreover, as described above, the processor 20 of this embodiment is realized with the special circuit through the first optimization of applying the VUPU processor to execute the original C language program as well as the second optimization of adapting the programmable VUPU processor to the real system. Accordingly, a reliable processor is developed at lower costs as well as in a shorter period, as compared with a method for directly designing and developing a C language program implementing processor that is entirely specialized by a special circuit.

As described above, the processor entirely implemented with the specialized circuit cannot flexibly deal with specification changes. Therefore, the processor directly developed with a specialized circuit either cannot deal with such specification changes, or must be re-designed with consuming an enormous amount of time. In contrast, the processor 20 of this embodiment can deal with specification changes by the program until the specification is determined. Moreover, since that programmable VUPU processor firstly developed has real-time response, the programmable processor itself can be actually supplied on the market as a product for actually incorporating into the system as an LSI for the application soon after the specification is issued.

If the specification is determined merely with a conventional programmable processor, a property such as real-time response changes significantly when the function of the conventional programmable processor is entirely implemented using a special circuit. As a result, a further change in the specification will be required after the implementation.

In contrast, the processor 20 having the VU and PU is based on the programmable VUPU processor 10 that has real-time response in the programmable stage, so that the specification can be determined with the equivalent processor regardless of whether the actual data-processing capability is programmable or not. In addition, the VU and PU in the processor 20 are the same of those of in the programmable processor 10. Accordingly, the VUPU processor 20 of this invention is developed in a short period, and also is highly reliable as well as capable of flexibly dealing with a change in the specification under the development. After the development, a compact, low-power consumption processor will result. Moreover, complete compatibility with the programmable VUPU can be ensured as a processor. Therefore, changing into a sequence method enables reduction in costs and power consumption without degrading predominance on the market, whereby the processor of the present invention can be provided as a further predominant processor.

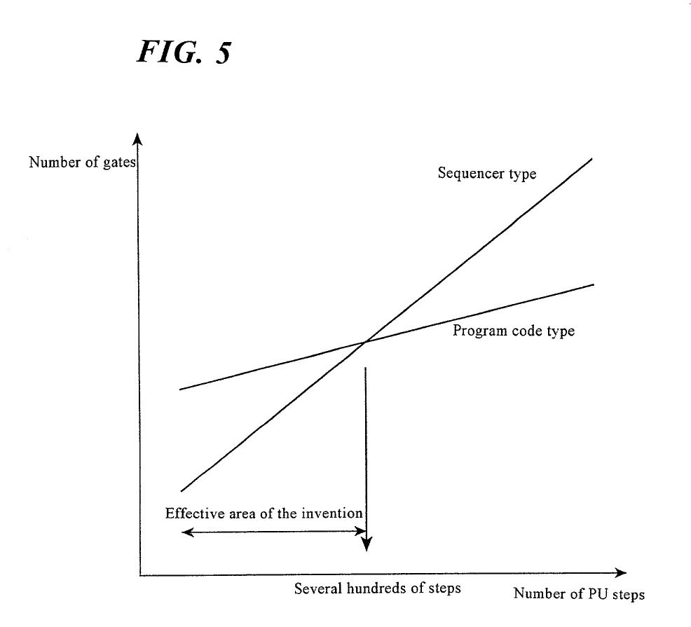

Note that, in the case where the VUPU processor conducts a processing of the C language program with a huge amount of program codes, the number of gates of the programmable DU of VUPU 10 is the same or increased only slightly, but the circuit scale for implementing the sequencer DU of VUPU 20 is so increased that reduces the advantage of implementing the DU using the sequencer. Although depending on the individual cases, the boundary of the merit between the VUPU 10 and VUPU 20 is around several hundreds of steps of the program codes of the PU, according to rough comparison between the number of gates for implementing the programmable DU 3 and the number of gates for realizing the DU 21 using a sequencer (embedded circuit), as shown in FIG. 5. Accordingly, the VUPU processor 20 of this invention is particularly suitable and most effective for the application executed by the processes with at most several hundreds of steps when the process described by the program.

Although the DU is realized by the sequencer in this embodiment, it may alternatively include the other type of special circuit such as wired logic or gate logic. Nevertheless, the sequencer method is one of the most appropriate methods for implementing the program codes with special circuit. Moreover, the real-time response of the VUPU processor of this embodiment has been ensured by the program control. Therefore, a further increase in the speed of the DU is not so strongly required. Thus, the sequencer may be the most appropriate method and hardware logic system in the present invention for implementing the function of the instruction issue unit.

As has been described above, in the architecture having PU, VU and DU for the VUPU processor, the instruction issue unit (DU) for issuing instructions to the PU and VU is implemented using hardware logic supplying the signals to the PU and VU associated with the programmable VUPU processor. Therefore, according to the present invention, a reliable, compact, low-power consumption data processing system is provided in a short period using the resources resulting from optimization with the programmable VUPU processor capable of flexibly dealing with the specification change while maintaining the real-time response.

What is claimed is:

1. A data processing system comprising:
a special purpose data processing unit being suitable for specific data processing and performed according to a special purpose instruction;
a general purpose data processing unit for executing processes according to general purpose instructions; and
an instruction issue unit for supplying signals corresponding to the special purpose instruction and the general purpose instructions to the special purpose data processing unit and the general purpose data processing unit respectively, the instruction issue unit being specialized of an application.

2. A data processing system according to claim 1, wherein the instruction issue unit includes a specialized circuit.

3. A data processing system according to claim 1, wherein the instruction issue unit is implemented using a hardware logic circuit.

4. A data processing system according to claim 1, wherein the instruction issue unit is a sequencer.

5. A data processing system according to claim 1, wherein the instruction issue unit supplies the signals equivalent to decoded control signals which are resultant of decoding of the special purpose instruction and the general purpose instructions in a program.

6. A data processing system according to claim 1, wherein the instruction issue unit outputs a signal corresponding to a nop instruction to the general purpose data processing unit when issuing the signal corresponding to the special purpose instruction to the special purpose data processing unit.

7. A data processing system according to claim 1, further comprises a plurality of special purpose data processing units.

8. A data processing system according to claim 1, wherein the special purpose data processing unit includes a specialized circuit.

9. A method for developing a data processing system including a special purpose data processing unit being suitable for specific data processing and performed according to a special purpose instruction; a general purpose data processing unit for executing processes according to general purpose instructions; and an instruction issue unit for supplying signals corresponding to the special purpose instruction and the general purpose instructions to the special purpose data processing unit and the general purpose data processing unit respectively, comprises;
a first step in which the instruction issue unit is programmable; and
a second step in which the instruction issue unit is specialized of an application.

10. A method for developing the data processing system according to claim 9, wherein the instruction issue unit of the second step supplies the signals equivalent to decoded control signals which are resultant of decoding of the special purpose instruction and the general purpose instructions of a program by the instruction issue unit of the first step.

11. A method for developing a data processing system including a special purpose data processing unit being suitable for specific data processing and performed according to a special purpose instruction; a general purpose data processing unit for executing processes according to general purpose instructions; and an instruction issue unit for supplying signals corresponding to the special purpose instruction and the general purpose instructions to the special purpose data processing unit and the general purpose data processing unit respectively, comprises,
a first optimization for developing the special purpose data processing unit for implementing a part of a specification of an application, and a program for performing the specification using the special purpose instruction and the general purpose instructions, and
a second optimization for optimizing the program using the data processing system in which the instruction issue unit is programmable.

12. A method for developing the data processing system according to claim 11, further comprising;
a third optimization for developing the instruction issue unit implemented using a hardware logic circuit for supplying the signals equivalent to decoded control signals which are resultant of decoding the special purpose instruction and the general purpose instructions of the program by the instruction issue unit of the second optimization.
